(19) United States
(12) Patent Application Publication
(10) Pub. No.: US 2008/0123364 A1
(43) Pub. Date: May 29, 2008

(54) STRUCTURE OF LIGHT GUIDE BOARD

(76) Inventors: Chia-Yin CHANG, Kaohsiung (TW); Chin-Fu Liu, Kaohsiung (TW)

Correspondence Address: LEONG C LEI, PMB # 1008, 1867 YGNACIO VALLEY ROAD, WALNUT CREEK, CA, 94598, US

(21) Appl. No.: 11/563,693

(22) Filed: Nov. 28, 2006

(51) Int. Cl. F21V 8/00

(52) U.S. Cl. 362/608

(57) ABSTRACT

A light guide board includes an incidence surface, an emitting surface, and a reflection surface. The incidence surface is frosted and has a roughness-enhanced zone corresponding in location to a light source. The emitting surface forms micro-structures on portions adjacent to the incidence surface and two opposite end surfaces. The portions of the emitting surface forming the micro-structures have magnitude increased roughness as compared to portions that are not provided with micro-structures so that light transmitting through the micro-structures is subject to further diffusion. The reflection surface forms a plurality of prisms extending from the incidence surface with a small (shallow) depth to an opposite surface with a large (deep) depth, with the height of the prisms increasing with the length thereof so that the prism surface of the prisms changes from minimum to maximum, which ensures uniformity of the light emitted from the light guide board.

### BACKGROUND OF THE INVENTION

(a) Technical Field of the Invention

The present invention relates to a structure of a light guide board, and in particular to a wedge-shaped light guide board for use in a backlight module.

(b) Description of the Prior Art

A backlight module is often incorporated in a liquid crystal display (LCD) for providing back lighting to the LCD. The backlight module, as a back lighting for LCD, is subject to server requirement of uniformity and brightness of light in order to provide the LCD with desired performance. As shown in FIG. 1 of the attached drawings, a conventional backlight module 1 comprises at least a light guide board 11, a reflector film 12, a number of optic films 13, and a light source 14.

The light guide board 11 has at least one light incidence surface 111, a reflection surface 112, and a light emitting surface 113. The light incidence surface 111 receives light from the light source 14 to allow the light to transmit into the interior of the light guide board 11. The reflection surface 112 serves to reflect and redirect the light transmitting inside the light guide board 11. The reflection surface 112 is provided with a plurality of light guide spots 1121, which are used to break total reflection of light on the reflection surface 112 so as to realize uniform light reflection. The light emitting surface 113 serves to give off the light from the light guide board 11.

A reflector film 12 is positioned on the reflection surface 112 of the light guide board 11 to reflect light traveling outside the light guide board 11 back into the light guide board 11.

The optic films 13 are arranged on the light emitting surface 113 of the light guide board 11. The optic films 13 include a diffusion film 131 that diffuse the light transmitting through the light guide board 11 and a prism film 132 that effects convergence of the light transmitting through the light guide board 11. The number and order of the optic films 13 can be varied as desired. The prism film 132 has a surface on which a plurality of minute prisms 1321 is formed and the prisms 1321 of two adjacent prisms films 132 are extended in perpendicular directions so as to effect all-direction light convergence.

The light source 14 supplies light to the light guide board 11 and is arranged outside the light incidence surface 111. Based on the requirement of different specification of merchandises using backlight modules, the light source 14 can be different numbers.

As described above, two prism films 132 are needed in the conventional backlight module 1 in order to effect convergence of light. However, the prism films 132 are expensive parts because the prism films are of a structure that is protected by patents and can be available from a limited number of suppliers.

FIG. 2 of the attached drawings illustrates a known backlight module 2, which is of enhanced brightness. The backlight module 2 comprises at least a light guide board 21, a reflector film 22, a prism film 23, a diffusion film 24, and a light source 25.

The light guide board 22 is of a wedge configuration and has a light incidence surface 211, a reflection surface 212, and a light emitting surface 213. The light incidence surface 211 receives light from the light source 25. The reflection surface 212 serves to reflect the component of light incident thereon. The light entwining emitting surface 213 serves to give off the light from the light guide board 21. The reflection surface 212 forms a plurality of juxtaposing prisms 2121 whereby light incident onto the reflection surface 212 is reflected by the prisms 2121 to effect convergence of light. The light so converged, after leaving the light guide board 21, is subject to further convergence by prisms 231 formed on the prism film 23 in a direction different from that of the prisms 2121 of the light guide board 21 thereby effecting all-direction convergence of the light.

Due to the wedge configuration, the reflection surface 212 of the light guide board 21 is inclined. In addition, the prisms 2121 formed on the reflection surface 212 serves to effect convergence of light, so that only one prism film 23 is needed. Thus, the backlight module 2 can have enhanced brightness of the emitted light as compared to the conventional backlight modules that use regular flat light guide boards.

The prisms 2121 formed on the reflection surface 212 effectively converge light and thereby enhance overall brightness of the light emitted from the light guide board 21. However, such a structure causes a portion of the light guide board that is close to the light incidence surface 211 to receive more optic energy than other portions and such optic energy, after being reflected by the prisms 2121 of the reflection surface 212, induces brightness zones, which are considered a flaw in the outside appearance and have to be overcome.

Therefore, it is desired to provide a light guide board for a backlight module of the above discussed type that overcomes the flaw of brightness zones.

### SUMMARY OF THE INVENTION

The primary purpose of the present invention is to provide a light guide board, which allows light that is received from a light source through a light incidence surface of the light guide board to be uniformly diffused and transmitted into the light guide board so as to eliminate brightness zone occurring in a light emitting surface due to insufficient diffusion of light in the light incidence surface.

Thus, an objective of the present invention is to provide a light guide board comprising light guide board comprising a light incidence surface, which is frosted and comprises a roughness-enhanced zone at a location corresponding to a light source, the roughness-enhanced zone having enhanced surface roughness as compared to a non-roughness-enhanced zone so that light from the light source is subject to diffusion by the frosted face of the light incidence surface and light that is radiated by the light source to the light incidence surface can be further diffused by the roughness-enhanced zone whereby the light incidence surface effects the optimum diffusion on the light from the light source and thus eliminating brightness zones occurring in the portions of the light emitting surface close to the light incidence surface due to insufficient diffusion of light by the light incidence surface.

Another objective of the present invention is to provide a light guide board having a light emitting surface, which forms micro-structures on portions thereof adjacent to a light incidence surface an two opposite end surfaces; whereby the portions of the light emitting surface are of magnitude enhanced roughness as compared to portions of the light emitting surface that are not provided with micro-structures. Thus, light transmitting through the light emitting surface can be of further diffusion to provide the output of light of the light guide board with uniformity.

A further objective of the present invention is to provide a light guide board having a light incidence surface that is inclined and comprises a roughness-enhanced zone that is inclined with the light incidence surface so as to enhance diffusion of light from a light source and to significantly improve refraction angle of the light entering the light guide board thereby preventing brightness zones from occurring at portions of the light emitting surface close to the light incidence surface.

A further objective of the present invention is to provide a light guide board having a reflection surface, which forms a plurality of prisms, which have a starting end connected with a light incidence surface and a terminating end connected with a surface opposite to the light incidence surface and which has a height increased from the starting end to the terminating end, whereby the variation of height of the prisms causes change of the prism surface of the prisms from minimum to maximum so that the light transmitting through the prism is subject to regulation by the variable area of the prism surface to provide uniform optic energy output and thus eliminating potential brightness zones of the light guide board.

A further objective of the present invention is to provide a light guide board having a reflection surface on which prisms are formed and the prisms have a starting end that is not connected with a light incidence surface and spaced from the light incidence surface by a distance so that the light entering the light guide board is not subject to immediate convergence by the prisms for coping with powerful light source.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

The present invention will be apparent to those skilled in the art by reading the following description of preferred embodiments thereof, with reference to the attached drawings, wherein:

FIG. 1 shows an exploded view of a conventional backlight module;

FIG. 2 shows an exploded view of another conventional backlight module;

FIG. 3 shows a schematic perspective view of a light guide plate constructed in accordance with the present invention;

FIG. 4 shows a perspective view, taken from a bottom side, of the light guide board of the present invention;

FIGS. 5 and 6 schematically show a light incidence surface of a light guide board constructed in accordance with another embodiments of the present invention;

FIGS. 7 and 9 schematically show a light emitting surface of a light guide board constructed in accordance with another embodiments of the present invention;

FIG. 10 shows a schematic side elevational view of a light guide board constructed in accordance with a further embodiment of the present invention; and

FIG. 11 shows a perspective view of a light guide board constructed in accordance with a further embodiment of the present invention.

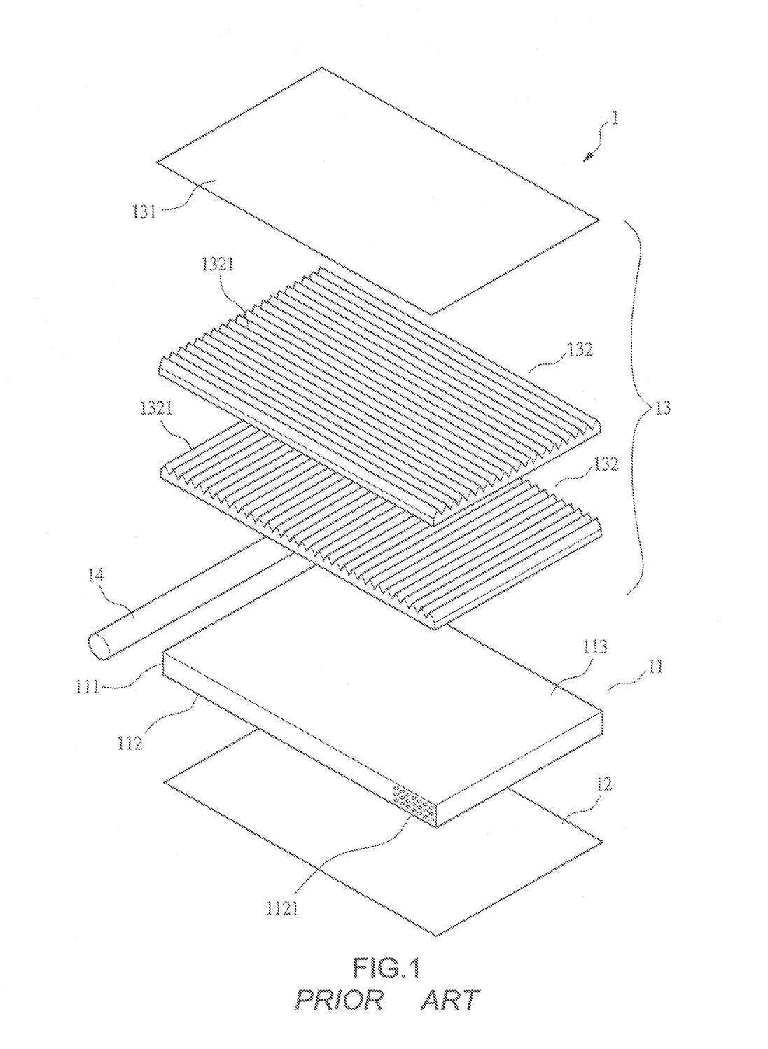

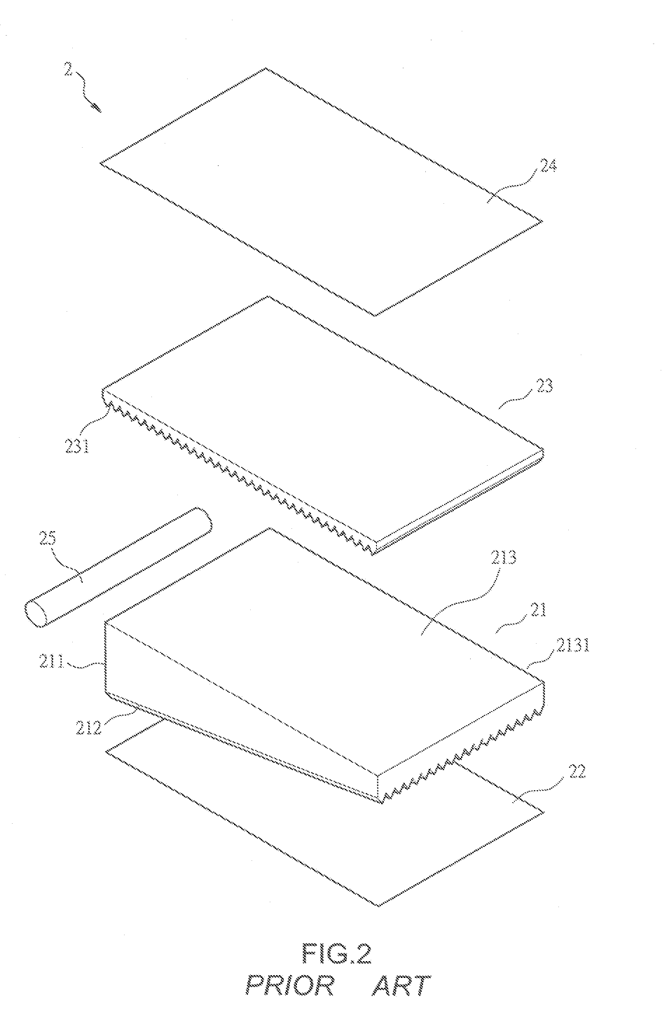

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

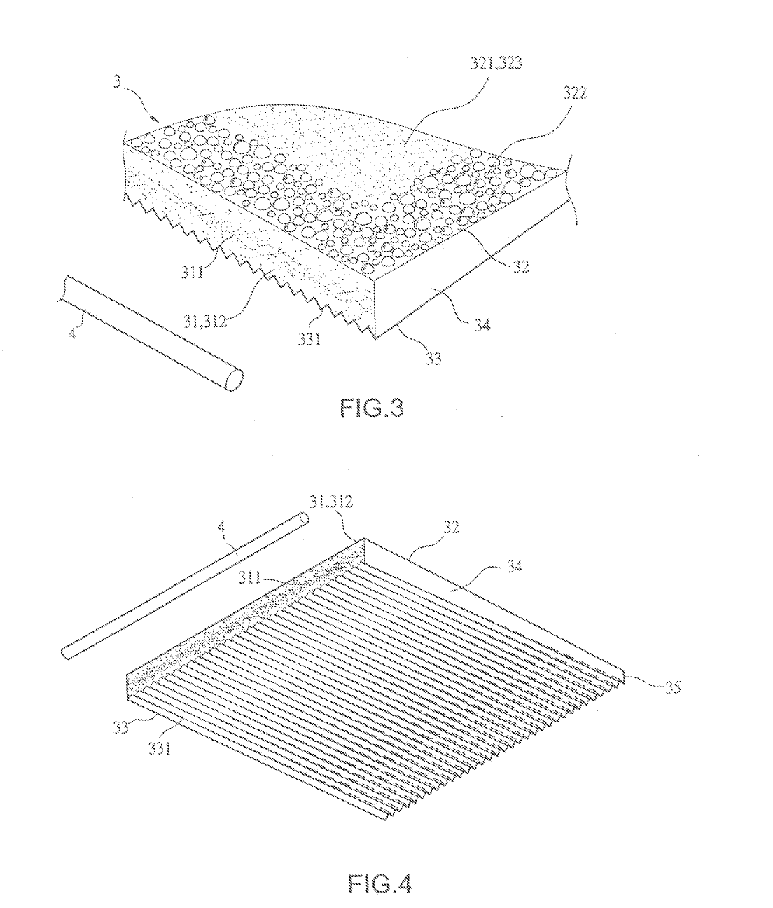

With reference to the drawings and in particular to FIG. 3, a light guide board constructed in accordance with the present invention, generally designated with reference numeral 3, is made of a material that has excellent light transmittance, such as glass and optic acrylic, and has at least a light incidence surface 31, a light emitting surface 32, and a reflection surface 33 opposite to the light emitting surface 32.

The light incidence surface 31 is a frosted surface and comprises a roughness-enhanced zone 311 at a range corresponding to the diameter of a tube of light source 4. The roughness-enhanced zone 311 has enhanced surface roughness as compared to a non-roughness-enhanced zone 312 of the light incidence surface 31.

The light emitting surface 32 comprises a frosted face or a face forming V-shaped grooves, of which only frosting is illustrated in the drawings. Portions of the light emitting surface 32 adjacent to the light incidence surface 321 and two opposite end surfaces 34 are provided with micro-structures 322, wherein the portions forming the micro-structures 322 are roughened with increased magnitude, and the micro-structures 322 can be made up of raised spots projecting beyond the light emitting surface 32.

As shown in FIG. 4, the reflection surface 33 comprises an inclined face on which a plurality of prisms 331 is formed. The prisms 331 extend in a direction substantially perpendicular to the light incidence surface 31. The prism 331 has a gradually increased height (depth) from a starting end 3311 of the prism 331 to a terminating end 3312 so that the starting end 3311 of the prism 331 has a small (shallow) depth and the depth increases from the starting end 3311 to the terminating end 33312, giving the terminating end 3312 a large (deep) depth. The starting end 3311 of the prism 331 is connected with the light incidence surface 31 of the light guide board 3, and the terminating end 3312 of the prism 331 is connected wit a surface 35 opposite to the light incidence surface 31.

The present invention provides a roughness-enhanced zone 311 on the light incidence surface 31 of the light guide board 31 at a range corresponding to the light source 4 and the roughness-enhanced zone 311 has enhanced roughness as compared to a non-roughness-enhanced zone 312, whereby the light from the light source 4 and received by the light incidence 31 is diffused by the frosting of the light incidence surface 31. Meanwhile, the light radiated from the light source 4 to the light incidence surface 31 is further diffused by the roughness-enhanced zone 311 so that the light incidence surface 31 of the light guide board 3 effects optimum diffusion of the light received from the light source 4, and thus eliminating brightness zones caused by insufficient light diffusion and occurring at the portion of the light emitting surface 32 close to the light incidence surface 31. The micro-structures 322 are arranged at the portions of the light emitting surface 32 that are adjacent to the light incidence surface 31 and the two opposite end surfaces 34 so that the portions of the light emitting surface 32 on which the micro-structures 322 are formed have magnitude-increased roughness to effect further diffusion of the light transmitting through the portions and thus enhancing uniformity of light emitted from the light guide board 3. Further, the reflection surface 33 of the light guide board 3 form densely distributed prisms 331 of which the starting end 3311 is connected with the light incidence surface 31 of the light guide board 3 and the terminating end 3312 is connected with the surface 35 opposite to the light incidence surface 31 with the depth (height) of the prism 331 increasing from a small (shallow) depth at the starting end 3311 to a large (deep) depth at the terminating end 3312. Thus, the height of the prism 331 is not fixed and varies with the length of the prism 331. The prism surface 331 is thus changed from minimum to maximum. Consequently, the light transmitting through the prism 331 is subject to regulation by the variable area of the prism surface to provide uniform optic energy output and thus eliminating potential brightness zones of the light guide board 3.

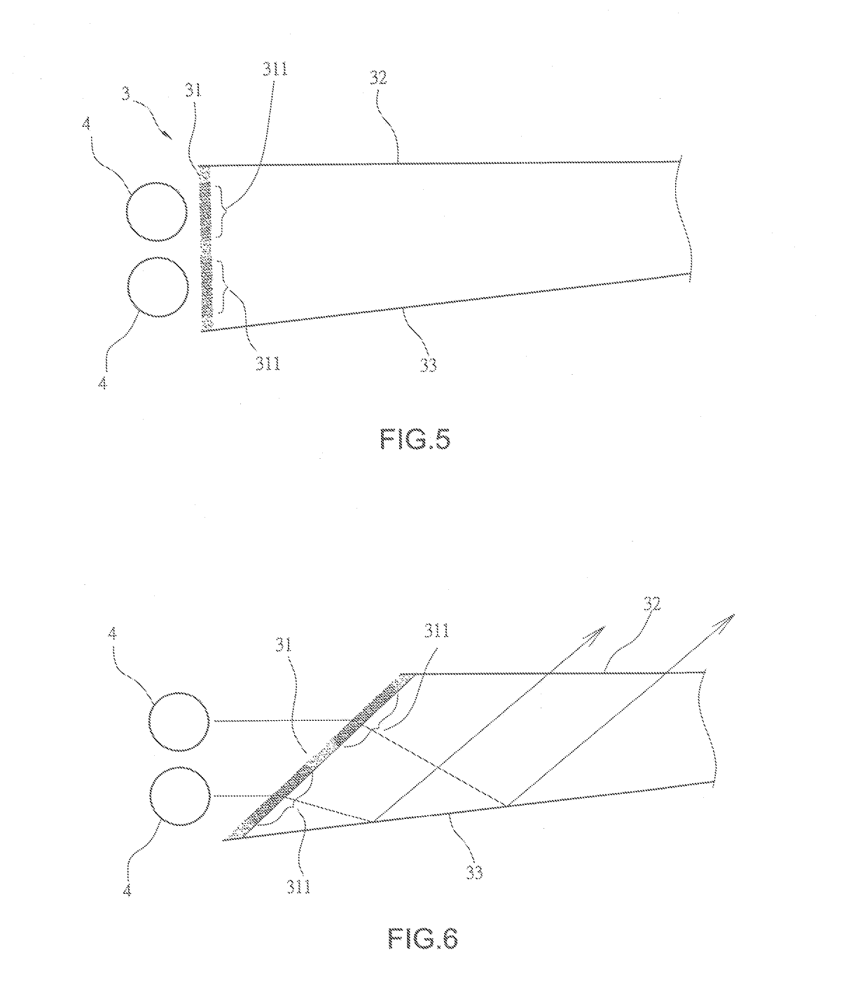

Also referring to FIG. 5, which illustrates another embodiment of the present invention, the roughness-enhanced zone 311 of the light incidence surface 31 can be increased in number to correspond multiple light sources 4 so that light from each light source 4 is subject to diffusion by the corresponding roughness-enhanced zone 311 to thereby effectively diffusing light from each light source 4.

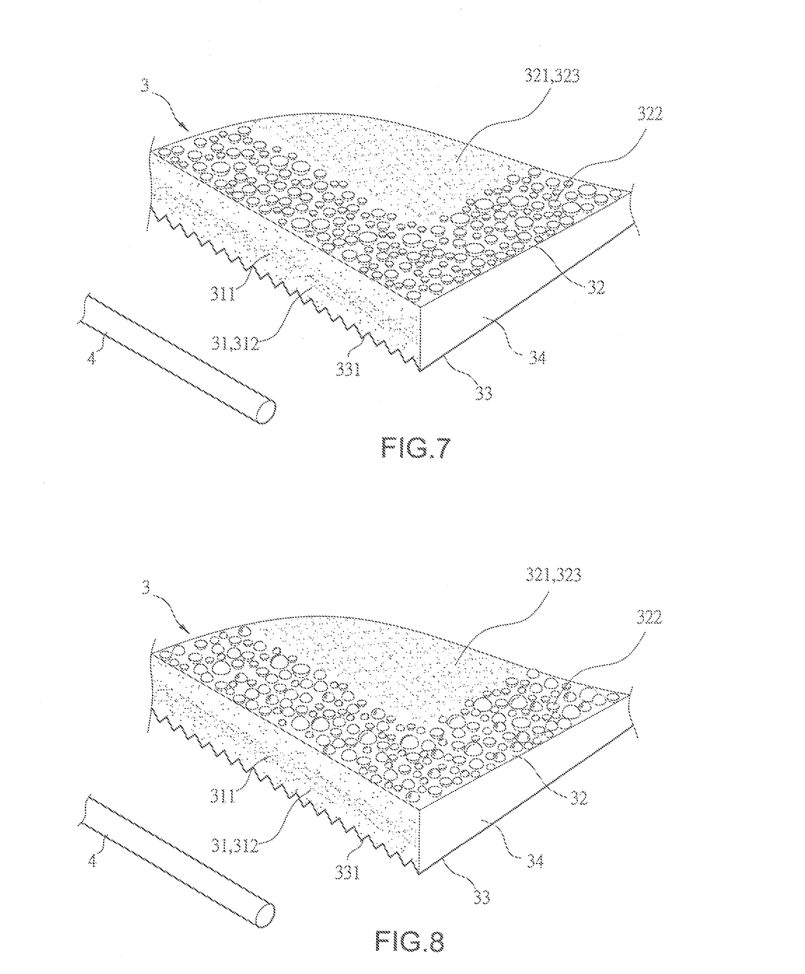

Also referring to FIG. 6, the light incidence surface 31 of the light guide board 3 in accordance with the present invention can be made inclined so that the roughness-enhanced zone 311 is also inclined. When light from the light source 4 transmits through the inclined light incidence surface 31, the light is, on one hand, diffused and, on the other hand, significantly improved in the refraction angle after entering the light guide board 3 so that the light is refracted and re-directed toward the reflection surface 33 that is distant from the light incidence surface 31, and is reflected by the reflection surface 33 to the light emitting surface 32, which is distant from the light incidence surface 31, to be emitted therefrom. This helps eliminating the brightness zones at portions of the light emitting surface 32 close to the light incidence surface 31. Also referring to FIG. 7, which illustrates another embodiment of the light guide board 3 in accordance with the present invention, the micro-structures 322 of the light emitting surface 32 are formed of recessed spots that are formed on the light emitting surface 32. Or alternatively, as shown in FIG. 8, the micro-structures 322 comprise both spot recesses and raised spots. The dimensions and depths and the density of distribution of the spots can be varied as desired so as to impose further variation on the roughness provided by the micro-structures 322, which in turn induces variation on diffusion of light.

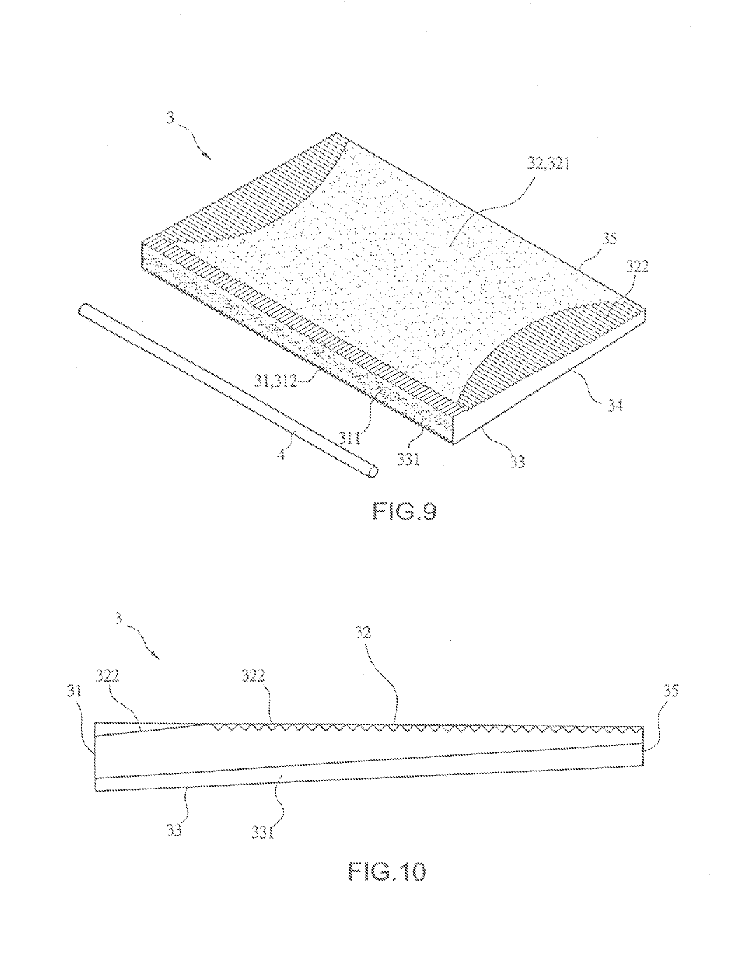

Also referring to FIG. 9, the micro-structures 322 of the light emitting surface 32 of the light guide board 3 can be formed of a plurality of ribs, of which height (depth), length, shape, direction, density of distribution can be respectively varied. If desired, variation of height can be provided in a single rib of the micro-structures 322, as illustrated in FIG. 10, so that the micro-structures 22 of the light emitting surface 32 of the light guide board 3 can be of further effect on refraction and reflection of light, as well as control of the direction of the refracted and/or reflected light.

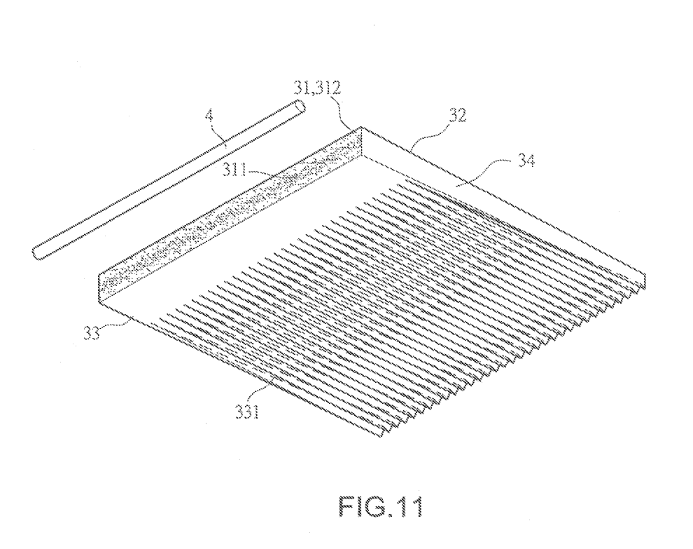

Also referring to FIG. 11, which illustrates another embodiment of the light guide board 3, the prisms 331 of the reflection surface 33 can be made in such a way that the starting ends 311 are not connected with the light incidence surface 31, but are instead spaced from the light incidence surface 31 by a distance so that light entering the light guide board 3 is not subject to immediate convergence by the prisms 331, which can be used to cope with a powerful light source.

Although the present invention has been described with reference to the preferred embodiments thereof, it is apparent to those skilled in the art that a variety of modifications and changes may be made without departing from the scope of the present invention which is intended to be defined by the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A light guide board comprising:
a light incidence surface, which is frosted and comprises a roughness-enhanced zone at a location corresponding to a light source arranged outside the light incidence surface;
a light emitting surface, which forms micro-structures on portions thereof adjacent to the light incidence surface and two opposite end surfaces; and
a reflection surface, which is inclined and forms a plurality of prisms,
wherein light from the light source is subject to diffusion by the roughness-enhanced zone of the light incidence surface; light transmitting through the portions of the light emitting surface is subject to further diffusion by the micro-structures of the light emitting surface; and the prisms of the reflection surface serves to regulate output of optic energy so as to prevent brightness zones from occurring in the light guide board.

2. The light guide board as claimed in claim 1, wherein the light incidence surface comprises a number of roughness-enhanced zones respectively corresponding to multiple light sources, where the number is one or more than one.

3. The light guide board as claimed in claim 1, wherein the light incidence surface is inclined.

4. The light guide board as claimed in claim 1, wherein roughness-enhanced zone of the light incidence surface has enhanced surface roughness as compared to a non-roughness-enhanced surface.

5. The light guide board as claimed in claim 1, wherein the micro-structures are formed of a plurality of raised spots that project beyond the light emitting surface.

6. The light guide board as claimed in claim 1, wherein the micro-structures are formed of a plurality of spot recesses defined in the light emitting surface.

7. The light guide board as claimed in claim 1, wherein the micro-structures are formed of both raised spots and spot recesses formed in the light emitting surface.

8. The light guide board as claimed in claim 1, wherein the micro-structures are formed of a plurality of grooves.

9. The light guide board as claimed in claim 1, wherein the light emitting surface has a portion that does not include a micro-structure and that is frosted.

10. The light guide board as claimed in claim 1, wherein the prism of the reflections has a small depth at a starting end, with the depth increased along with length of the prisms so as to have a large depth at a terminating end.

11. The light guide board as claimed in claim 1, wherein the prism of the reflection surface has a starting end connected with the light incidence surface of the light guide board and a terminating end connected with a surface opposite to the light incidence surface.

12. The light guide board as claimed in claim 1, wherein the prism of the reflection surface has a starting end spaced from the light incidence surface of the light guide board by a distance and a terminating end connected with a surface opposite to the light incidence surface.
